(19) United States
(12) Patent Application Publication
(10) Pub. No.: US 2025/0282006 A1
(43) Pub. Date: Sep. 11, 2025

(54) WELDING STRUCTURE, WELDING DEVICE AND WELDING METHOD

(71) Applicant: CRRC QINGDAO SIFANG CO., LTD., Qingdao, Shandong (CN)

(72) Inventors: Xiaohui HAN, Shandong (CN); Yong LIU, Shandong (CN); Zhiyi ZHANG, Shandong (CN); Ye XU, Shandong (CN); Wenjian LIANG, Shandong (CN); Jianwei LIU, Shandong (CN); Hongyu SONG, Shandong (CN)

(21) Appl. No.: 18/847,081

(22) PCT Filed: Oct. 12, 2022
(86) PCT No.: PCT/CN2022/124835

§ 371 Date: Sep. 13, 2024

(30) Foreign Application Priority Data
Mar. 22, 2022 (CN) 202210287846.2

(51) Int. Cl. B23K 37/04; B23K 26/348; B23K 31/00; B23K 101/18

(52) U.S. Cl. CPC B23K 37/0408; B23K 26/348; B23K 31/003; B23K 37/0461; B23K 2101/18

(57) ABSTRACT

A welding structure, comprising: a first cover plate (10), a second cover plate (20), web plates (30), and rib plates (40). The first cover plate (10) and the second cover plate (20) are arranged at an interval. Multiple web plates (30) are arranged at intervals in a first direction, and are insertingly fitted to the first cover plate (10) and the second cover plate (20), respectively. Multiple rib plates (40) are arranged at intervals in a second direction, and are insertingly fitted to the first cover plate (10) and the second cover plate (20), respectively. The first direction and the second direction are perpendicular to each other. The web plates (30) and the rib plates (40) are insertingly fitted to each other. According to the welding structure, upper and lower cover plates of a box-shaped structure are insertingly connected and interlocked to form a stable closed box-shaped structure, so that the rigidity of the structure is improved. Also provided are a welding device and a welding method.

### CROSS-REFERENCES TO RELATED APPLICATIONS

The present application claims priority to Chinese patent application No. 2022102878462 filed on Mar. 22, 2022, entitled “Welding structure, Welding device and Welding method”, which is hereby incorporated by reference in its entirety.

### FIELD

The present application relates to the field of welding, and in particular, to a weld structure, a weld device and a weld method.

### BACKGROUND

An underframe bolster beam, a traction beam and a bogie frame side beam at the end of a vehicle body are the most important load-bearing components of rail vehicles. Since the rail vehicles are subjected to severe alternating load conditions during operation, multi-layer and multi-pass melt active gas (MAG) arc welding process is adopted to ensure good load-bearing service capacity of the rail vehicles. A large heat input of arc welding results in serious welding deformation and a lot of manpower and material resources are required after welding for adjustment and correction, resulting in strength loss and performance degradation. An added back pad seriously reduces fatigue resistance of a box-shaped structure.

### BRIEF SUMMARY

The present application provides a weld structure which solves defects that a traditional box-shaped structure needs to be adjusted and corrected, resulting in strength loss and performance degradation. A stable and enclosed box-shaped structure is formed by inserting and interlocking the upper and lower cover plates, and the rigidity of the box-shaped structure is increased.

The present application further provides a weld device for a weld structure, which solves defects of strength loss and performance degradation due to manual adjustment and correction, inability to effectively suppress welding deformation, large workload of repeated check, inability to accurately and dynamically adjust the weld structure based on the evolution trend of deformation and change amount of a weld structure, and poor anti-deformation effect. By providing multi-point flexible support at a support surface, welding deformation is finely controlled, welding defects are precisely suppressed, microstructure performance is effectively improved, the manufacturing accuracy is increased, the manufacturing cost is reduced, and the production efficiency is greatly improved.

The present application further provides a weld method of a weld device, which solves defects of inability to avoid adjustment and correction to a weld structure, inability to effectively suppress welding deformation, large workload of repeated check, inability to accurately and dynamically adjust the weld structure based on the evolution trend of deformation and change amount of a weld structure, and poor anti-deformation effect. By adjusting a magnitude of the multi-point flexible force at the support surface, zero-gap rapid and precise assembly, multi-point flexible constraint and multi-energy field coordinated high-performance welding are provided, and engineering goals of fine control of welding deformation, effective suppression of welding defects and substantial improvement of weld microstructure performance are simultaneously achieved.

An embodiment of the present application provides a weld structure, including:
a first cover plate, a second cover plate, a plurality of web plates and a plurality of rib plates,
where the first cover plate and the second cover plate are arranged at intervals;
the web plates are arranged at intervals along a first direction and are insertedly matched with the first cover plate and the second cover plate, respectively;
the rib plates are arranged at intervals along a second direction and are insertedly matched with the first cover plate and the second cover plate, respectively;
the first direction and the second direction are perpendicular to each other; and
the web plates and the rib plates are insertedly matched with each other.

In an embodiment, a surface of the first cover plate is provided with a plurality of first slots and a plurality of second slots,
where the first slots are arranged at intervals along the first direction and each of the first slots is insertedly matched with each of the web plates;
the second slots are arranged at intervals along the second direction and each of the second slots is insertedly matched with each of the rib plates; and
grooves are provided at sides of each of the first slots and the second slots facing the second cover plate.

The present embodiment provides the first cover plate, and the first cover plate is insertedly matched with the web plates and the rib plates by providing the first slots and the second slots.

Furthermore, the grooves are provided at the sides of each of the first slots and the second slots facing the second cover plate, which facilitates the zero-gap rapid and precise assembly of the inserted interlocking structure. By providing the grooves, the back forming of the weld is further improved and the penetration of a weld root is improved, which not only meets the assembly requirements but also improves the assembly efficiency.

In an embodiment of the present application, a surface of the second cover plate is provided with a plurality of third slots and a plurality of fourth slots,
where the third slots are arranged at intervals along the first direction and each of the third slots is insertedly matched with each of the web plates;
the fourth slots are arranged at intervals along the second direction and each of the fourth slots is insertedly matched with each of the rib plates; and
grooves are provided at sides of each of the third slots and the fourth slots facing the first cover plate.

The present embodiment provides the second cover plate, and the second cover plate is insertedly matched with the web plates and the rib plates by providing the third slots and the fourth slots.

Furthermore, the grooves are provided at sides of each of the third slots and the fourth slots facing the second cover plate, which facilitates the zero-gap rapid and precise assembly of the inserted interlocking structure. By providing the groove, the back forming of the weld is further improved and the penetration of a weld root is improved, which not only meets the assembly requirements but also improves the assembly efficiency.

In an embodiment of the present application, the first cover plate, the second cover plate, the web plates and the rib plates are all made of high-strength weather-resistant steel.

The present embodiment provides a material of the weld structure. With the increase of the running speed of the vehicle and urban rail trains, a requirement for lightweight trains is more urgent. Common low-alloy steel is replaced with the high-strength weather-resistant steel to achieve a lightweight design, which utilizes engineering characteristics of the high-strength weather-resistant steel, such as high strength, good plasticity, excellent fatigue performance and good economy.

An embodiment of the present application further provides a weld device for a weld structure, including: a support portion, a weld portion and an adjustment portion,
where the support portion is formed with a support surface for supporting the weld structure;
the weld portion is connected to the support portion for welding the weld structure; and
the adjustment portion is connected to the support portion and abuts against a weld surface of the weld structure,
where during a welding process of the weld structure by the weld portion, the adjustment portion regulates a flatness of the weld structure by adjusting a magnitude of a force acting on the weld surface of the weld structure.

In an embodiment, the support portion includes a support table and a drive unit,
where a surface of the support table forms the support surface; and
the drive unit is connected to the support table to adjust a rotation angle of the support table.

The present embodiment provides the support portion. The weld structure is supported by providing the support table, and the support table is flappable through the drive unit and requirements of welding are satisfied from different angles.

In an embodiment, the weld portion is a laser-arc hybrid welding mechanism connected with the support portion.

The present embodiment provides the weld portion. By combining laser-arc hybrid welding with the support portion and the adjustment portion, an entire manufacturing process from development of a product structure, research and development on the weld device to control of a welding process is innovated systematically, barriers of difficult assembly, low efficiency and poor stability of a closed box-shaped structure using traditional laser-arc hybrid welding are effectively broken through, engineering problems that a laser-arc hybrid welding gun has a large size and a traditional assembly mode has many spatial interferences are solved, and bottlenecks that welding porosity is difficultly to avoid and a back has poor forming during laser-arc hybrid welding of medium and thick plates are broken through.

In an embodiment, the adjustment portion includes: a plurality of magnetic units and a plurality of sensor units,
where the magnetic units are arranged at the support table to position the weld structure through magnetic adsorption; and
the sensor units are arranged at the support table to feed back welding parameters used in the welding process of the weld structure to the weld portion.

The present embodiment provides the adjustment portion, and the magnetic units and the sensor units are arranged at a surface of the support table, that is, the support surface, to position the closed box-shaped weld structure made of the high-strength weather-resistant steel and obtain corresponding parameters during the welding process, and engineering goals of fine control of weld deformation, effective suppression of weld defects and significant improvement of weld structure performance are obtained.

An embodiment of the present application further provides a weld method based on a weld device, including:
obtaining a first weld characteristic value of the weld structure during a welding process, where the first weld characteristic value is a deformation amount parameter of the weld structure;
generating a first adjustment strategy for regulating a deformation amount of the weld surface of the weld structure based on the first weld characteristic value; and
performing anti-deformation adjustment in real time at the weld structure during the welding process based on the first adjustment strategy.

In an embodiment, obtaining the first weld characteristic value of the weld structure during the welding process includes:
obtaining a first deformation characteristic value, a second deformation characteristic value and a third deformation characteristic value of the weld structure during the welding process, where the first deformation characteristic value is a deformation area parameter of the weld structure, the second deformation characteristic value is a deformation force parameter corresponding to the first deformation characteristic value, and the third deformation characteristic value is a friction force parameter corresponding to the first deformation characteristic value; and
generating the first weld characteristic value based on the first deformation characteristic value, the second deformation characteristic value and the third deformation characteristic value.

The present embodiment provides obtaining the first weld characteristic value of the weld structure during the welding process, and corresponding first weld characteristic value is generated by obtaining the deformation characteristic value of the weld structure during the welding process.

In an embodiment, generating the first adjustment strategy for regulating the deformation amount of the weld surface of the weld structure based on the first weld characteristic value includes:
obtaining a preset adjustment area corresponding to the weld surface of the weld structure, and obtaining all adjustment portions in the preset adjustment area based on the first deformation characteristic value;
generating a first adjustment characteristic value of each of obtained adjustment portions based on the second deformation characteristic value, where the first adjustment characteristic value is an adsorption force parameter of each of the obtained adjustment portions;
generating a second adjustment characteristic value of each of the obtained adjustment portions based on the second deformation characteristic value and the third deformation characteristic value, where the second adjustment characteristic value is a friction force parameter between each of the obtained adjustment portions and the weld structure; and
generating the first adjustment strategy for the preset adjustment area based on the first adjustment characteristic value and the second adjustment characteristic value.

The present embodiment provides an implementation for generating the first adjustment strategy for regulating the deformation amount of the weld surface of the weld structure, anti-deformation adjustment of the weld structure during the welding process is implemented by adjusting a magnitude of an adsorption force of the magnetic unit corresponding to the deformation area based on the adsorption force parameter.

Furthermore, when the magnitude of the adsorption force of the magnetic unit is adjusted, the friction force parameter needs to be monitored to avoid the problem that the weld structure moves during the welding process due to insufficient adsorption force.

In an embodiment, generating the first adjustment strategy for the preset adjustment area based on the first adjustment characteristic value and the second adjustment characteristic value includes:
constructing a digital twin model based on the weld structure;
obtaining a first twin adjustment characteristic value of the digital twin model based on the first adjustment characteristic value;
obtaining a second twin adjustment characteristic value of the digital twin model based on the second adjustment characteristic value;
performing a determination based on the second twin adjustment characteristic value; and
generating the first adjustment strategy based on the first adjustment characteristic value in accordance with a determination that the second twin adjustment characteristic value satisfies a preset adsorption condition; or
generating the first adjustment strategy based on the second adjustment characteristic value in accordance with a determination that the second twin adjustment characteristic value does not satisfy a preset adsorption condition.

The present embodiment provides an implementation for generating the first adjustment strategy based on the preset adjustment area. By constructing the digital twin model, the anti-deformation amount of the weld structure is calculated, and the adsorption force parameter between the support table and the weld structure are verified, to avoid the problem that the weld structure moves on the support table due to insufficient adsorption force of the magnetic unit.

In an embodiment, performing anti-deformation adjustment in real time at the weld structure during the welding process based on the first adjustment strategy includes:
obtaining an instant weld area of the weld structure and dynamically fitting the instant weld area with the preset adjustment area;
obtaining a dynamically fit first instant adjustment area and a dynamically fit second instant adjustment area, where the first instant adjustment area is an area corresponding to first deformation characteristic value, and the second instant adjustment area is an area within a preset range around the first instant adjustment area;
obtaining a magnetic field distortion parameter in the second instant adjustment area and performing a determination; and
generating the first adjustment strategy based on a preset distortion threshold in accordance with a determination that the magnetic field distortion parameter does not satisfy the preset distortion threshold.

The present embodiment provides performing anti-deformation adjustment in real time at the weld structure. By monitoring the magnetic field within the preset range around the deformation area of the weld structure, a problem of excessive disturbance to the magnetic field in the surrounding area caused by adjusting the magnetic unit corresponding to the deformation area is avoided, the weld quality is guaranteed, and dynamic regulation of welding deformation in the hybrid welding process is satisfied to ensure engineering requirements of accurate weld position and enhanced weld stability.

In an embodiment, after performing anti-deformation adjustment in real time at the weld structure during the welding process based on the first adjustment strategy, the method further includes:
obtaining a second weld characteristic value and a third weld characteristic value of the weld structure during the welding process, where the second weld characteristic value is a welding trajectory parameter of the weld structure, and the third characteristic value is a weld pool parameter of the weld structure;
generating a second adjustment strategy for regulating a magnetic field direction of the adjustment portion based on the second weld characteristic value and the third weld characteristic value; and
stirring the weld pool of the weld structure during the welding process using magnetic field in real time based on the second adjustment strategy.

The present embodiment provides stirring the weld pool of the weld structure using the magnetic field. By coupling and regulating laser and arc energy fields of the laser-arc hybrid welding using an alternating magnetic field generated by the magnetic unit, a plasma is effectively suppressed, a droplet flight speed and a weld pool flow speed of the laser-arc hybrid welding are increased, the thermal transmission and energy efficiency of the laser and arc are improved, and more stable droplet transition and better arc directivity are obtained. A stirring effect of the magnetic field is formed inside the weld pool to further refine the weld grain structure and enhance the gas escape capability. The mechanical properties and fatigue strength of a hybrid weld joint under the superposition of the magnetic field are improved by at least 5% compared with a traditional hybrid weld joint.

The above one or more solutions in the present application have at least one of the following effects: in the weld structure, the weld device and the weld method provided by the present application, the box-shaped structure is inserted and interlocked by using the upper and lower cover plates, and a stable closed box-shaped structure is formed to increase the rigidity of the structure.

Additional aspects and advantages of the present application will be set forth in part in the description which follows and, in part, will be apparent from the description, or may be learned through practice of the present application.

### BRIEF DESCRIPTION OF THE DRAWINGS

To more clearly illustrate solutions in the present application or the related art, the accompanying drawings used in the description of the embodiments or the related art are briefly introduced below. It should be noted that the drawings in the following description are only some embodiments of the present application. For those of ordinary skill in the art, other drawings may be obtained based on these drawings without creative effort.

FIG. 1 is a first assembly schematic diagram of a weld structure according to the present application;

FIG. 2 is a second assembly schematic diagram of a weld structure according to the present application;

FIG. 3 is a third assembly schematic diagram of a weld structure according to the present application;

FIG. 4 is a fourth assembly schematic diagram of a weld structure according to the present application;

FIG. 5 is a fifth assembly schematic diagram of a weld structure according to the present application;

FIG. 6 is a layout schematic diagram of a weld device according to the present application; and

FIG. 7 is a schematic flowchart of a weld method according to the present application.

### REFERENCE NUMERALS

10: first cover plate; 11: first slot; 12: second slot;
20: second cover plate; 21: third slot; 22: fourth slot;
30: web plate;
40: rib plate;
50: groove;
60: support table;
70: drive unit;
80: magnetic unit;
90: sensor unit;
100: weld portion.

### DETAILED DESCRIPTION

To make the purpose, solutions and advantages of embodiments of the present application clearer, solutions in the embodiments of the present application will be described clearly and completely in conjunction with the drawings in the embodiments of the present application. The described embodiments are part of the embodiments of the present application, not all of the embodiments. Based on the embodiments in the present application, all other embodiments obtained by those skilled in the art without creative work are within the scope of protection of the present application.

In the description of the present application, it should be noted that, the orientation or positional relations specified by terms such as “central”, “longitudinal”, “traverse”, “upper”, “lower”, “front”, “back”, “left”, “right”, “vertical”, “horizontal”, “top”, “bottom”, “inner”, “outer” and the like, are based on the orientation or positional relations shown in the drawings, which is merely for convenience of description of the present application and to simplify description, but does not indicate or imply that the stated devices or components must have a particular orientation and be constructed and operated in a particular orientation, and thus it is not to be construed as limiting the present application. Furthermore, the terms “first”, “second”, “third” and the like are only used for descriptive purposes and should not be construed as indicating or implying a relative importance.

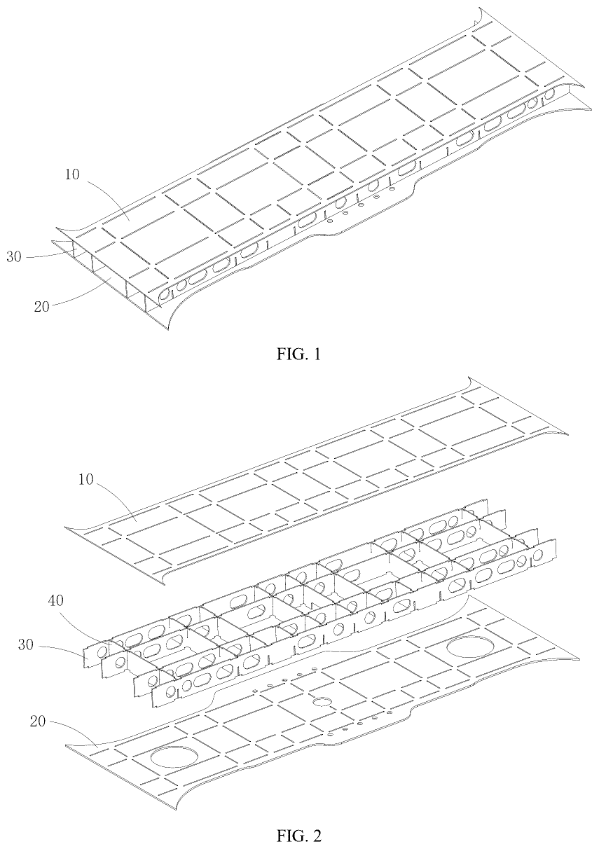

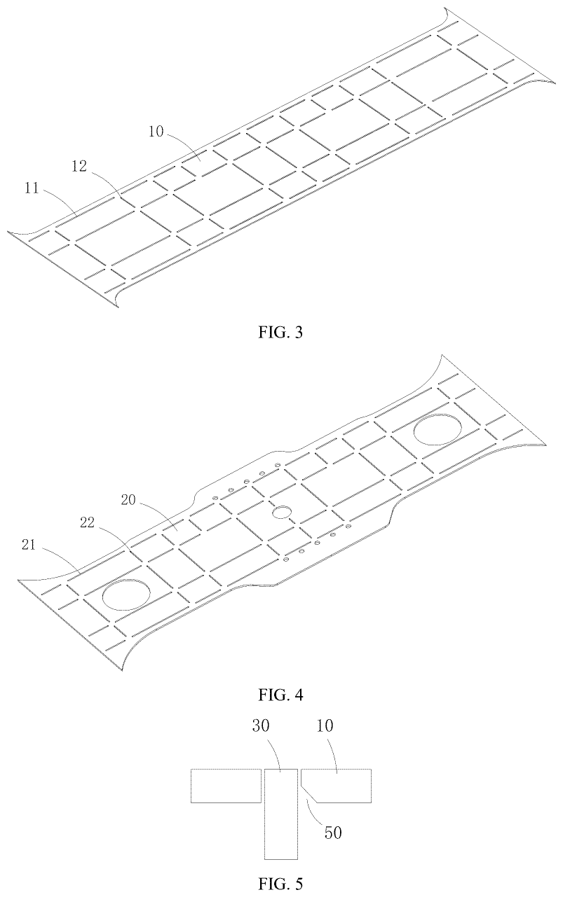

In some specific embodiments of the present application, as shown in FIG. 1 to FIG. 5, the present embodiment provides a weld structure, including: a first cover plate 10, a second cover plate 20, a plurality of web plates 30 and a plurality of rib plates 40. The first cover plate 10 and the second cover plate 20 are arranged at intervals. The web plates 30 are arranged at intervals along a first direction and are insertedly matched with the first cover plate 10 and the second cover plate 20, respectively and the rib plates 40 are arranged at intervals along a second direction and are insertedly matched with the first cover plate 10 and the second cover plate 20, respectively, the first direction and the second direction are perpendicular to each other and the web plates 30 and the rib plates 40 are insertedly matched with each other.

The present application provides a weld structure which solves defects that a traditional box-shaped structure needs to be adjusted and corrected, resulting in strength loss and performance degradation. A stable and enclosed box-shaped structure is formed by inserting and interlocking the upper and lower cover plates, and the rigidity of the box-shaped structure is increased.

In some embodiments of the present application, a surface of the first cover plate 10 is provided with a plurality of first slots 11 and a plurality of second slots 12. The first slots 11 are arranged at intervals along the first direction, and each of the first slots 11 is insertedly matched with each of the web plates 30 in a one-to-one correspondence. The second slots 12 are arranged at intervals along the second direction, and each of the second slots 12 is insertedly matched with each of the rib plates 40 in a one-to-one correspondence. Grooves 50 are provided at sides of each of the first slots 11 and the second slots 12 facing the second cover plate 20.

Specifically, the present embodiment provides the first cover plate 10, and the first cover plate 10 is insertedly matched with the web plates 30 and the rib plates 40 by providing the first slots 11 and the second slots 12.

Further, the grooves 50 are provided at the sides of each of the first slot 11 and the second slot 12 facing the second cover plate 20, which facilitates the zero-gap rapid and precise assembly of the inserted interlocking structure. By providing the groove 50s, the back forming of the weld is further improved and the penetration of a weld root is improved, which not only meets the assembly requirements but also improves the assembly efficiency.

In a possible implementation, the groove 50 is a single V-shaped groove provided at the side of the first cover plate 10 facing the second cover plate 20.

In some embodiments of the present application, a surface of the second cover plate 20 is provided with a plurality of third slots 21 and a plurality of fourth slots 22. The third slots 21 are arranged at intervals along the first direction, and each of the third slots 21 is insertedly matched with each of the web plates 30 in a one-to-one correspondence. The fourth slots 22 are arranged at intervals along the second direction, and each of the fourth slots 22 is insertedly matched with each of the rib plate 40 in a one-to-one correspondence. Grooves 50 are provided at sides of each of the third slots 21 and the fourth slots 22 facing the first cover plate 10.

The present embodiment provides the second cover plate 20, and the second cover plate 20 is insertedly matched with the web plates 30 and the rib plates 40 by providing the third slots 21 and the fourth slots 22.

Furthermore, the grooves 50 are provided at the sides of each of the third slots 21 and the fourth slots 22 facing the second cover plate 10, which facilitates the zero-gap rapid and precise assembly of the inserted interlocking structure. By providing the groove 50, the back forming of the weld is further improved and the penetration of a weld root is improved, which not only meets the assembly requirements but also improves the assembly efficiency.

In a possible implementation, the groove 50 is a single V-shaped groove provided at the side of the first cover plate 10 facing the second cover plate 20.

In some possible embodiments of the present application, the first cover plate 10, the second cover plate 20, the web plates 30 and the rib plates 40 are all made of high-strength weather-resistant steel.

The present embodiment provides a material of the weld structure. With the increase of the running speed of the vehicle and urban rail trains, a requirement for lightweight trains is more urgent. Common low-alloy steel is replaced with the high-strength weather-resistant steel for providing lightweight design, which utilizes engineering characteristics of the high-strength weather-resistant steel, such as high strength, good plasticity, excellent fatigue performance, and good economy.

In a possible implementation, the weld structure is made of high-strength weather-resistant steel, and the thickness is thinned from the original 8 to 12 mm to 5 to 8 mm, which is at least 20% lighter than a traditional closed box-shaped structure.

In a possible implementation, the weld structure is applied to a chassis of a rail vehicle.

In a possible implementation, the weld structure is a bolster beam of the rail vehicle.

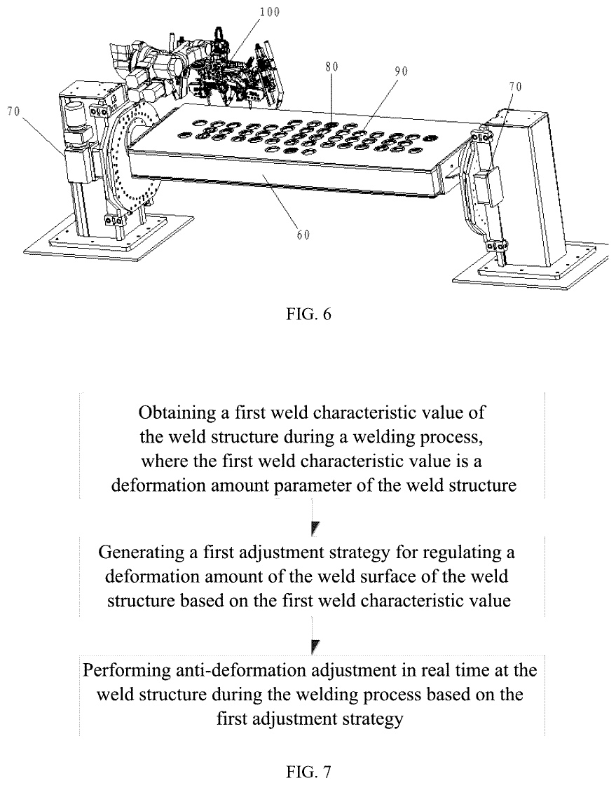

In an embodiment of the present application, as shown in FIG. 1 to FIG. 6, the present solution provides a weld device for a weld structure, including a support portion, a weld portion 100 and an adjustment portion. The support portion is formed with a support surface for supporting the weld structure; the weld portion 100 is connected to the support portion for welding the weld structure; the adjustment portion is connected to the support portion and abuts against a weld surface of the weld structure. During a welding process of the weld structure by the weld portion, the adjustment portion regulates a flatness of the weld structure by adjusting a magnitude of a force acting on the weld surface of the weld structure

The present application further provides the weld device for the weld structure, which solves defects of strength loss and performance degradation due to manual adjustment and correction, inability to effectively suppress welding deformation, large workload of repeated check, inability to accurately and dynamically adjust the weld structure based on the evolution trend of deformation and change amount of a weld structure, and poor anti-deformation effect. By providing multi-point flexible support at a support surface, welding deformation is finely controlled, welding defects are precisely suppressed, microstructure performance is effectively improved, the manufacturing accuracy is increased, the manufacturing cost is reduced, and the production efficiency is greatly improved.

In some possible embodiments of the present application, the support portion includes a support table 60 and a drive unit 70. A surface of the support table 60 forms a support surface and the drive unit 70 is connected to the support table 60 to adjust the rotation angle of the support table 60.

The present embodiment provides the support portion. The weld structure is supported by providing the support table 60, and the support table 60 is flappable through the drive unit and requirements of welding are satisfied from different angles. It should be noted that a traditional bolster beam is welded using a single welding

mechanism, that is, a single welding gun. In the process of welding the bolster beam, there are problems such as manual turning, repeated positioning and clamping, which makes it difficult to clamp and form the bolster in one step. Therefore, the processing accuracy of the bolster beam is affected and the labor intensity is increased. Meanwhile, the bolster beam is supported singly in the related art and the post-welding manufacturing accuracy of the box-shaped bolster structure still does not meet the adjustment-free standard under a single welding deformation suppression measure.

It should also be noted that the present application does not limit the specific structure of the drive unit 70. The drive unit 70 includes a motor, a bearing, a support mechanism, a transmission mechanism, etc. For simplicity, the specific structure of the drive unit 70 are not elaborated too much in the present application. In practical applications, those skilled in the art can refer to the arrangement in related fields as required.

In some possible embodiments of the present application, the weld portion 100 is a laser-arc hybrid welding mechanism connected with the support portion.

The present embodiment provides the weld portion 100. By combining laser-arc hybrid welding with the support portion and the adjustment portion, an entire manufacturing process from development of a product structure, research and development on the weld device to control of a welding process is innovated systematically, barriers of difficult assembly, low efficiency and poor stability of a closed box-shaped structure using traditional laser-arc hybrid welding are effectively broken through, engineering problems that a laser-arc hybrid welding gun has a large size and a traditional assembly mode has many spatial interferences are solved, and bottlenecks that welding porosity is difficult to avoid and a back has poor forming during laser-arc hybrid welding of medium and thick plates are broken through.

In a possible implementation, laser-arc hybrid welding cooperates with the groove 50 of the corresponding weld seam at the back of the weld structure, which greatly facilitates the escape of gas inside the weld pool of the laser-arc hybrid welding from the back of the weld pool, and effectively suppresses the welding porosity defects of laser-arc hybrid welding of a medium and thick plate.

In a possible implementation, the laser-arc hybrid welding mechanism completes the welding using a process of one-time welding and forming of a weld surface during the welding process of the weld structure.

In some embodiments of the present application, the adjustment portion includes a plurality of magnetic units 80 and a plurality of sensor units 90. The magnetic units 80 are arranged at the support table 60 to position the weld structure through magnetic adsorption; and the sensor units 90 are arranged at the support table 60 to feed back welding parameters used in the welding process of the weld structure to the weld portion 100.

The present embodiment provides the adjustment portion, and the magnetic units 80 and the sensor units 90 are arranged at a surface of the support table 60, that is, the support surface, to position the closed box-shaped weld structure made of the high-strength weather-resistant steel and obtain corresponding parameters during the welding process, and engineering goals of fine control of weld deformation, effective suppression of weld defects and significant improvement of weld structure performance are obtained.

It should be noted that the enclosed box-shaped structure of high-strength weather-resistant steel is complex, with a large number of weld seams, a small welding spacing (the minimum spacing is 5 mm), and strict assembly requirements, and the assembly error must be controlled within the range of 0 to 0.5 mm and assembly is difficult, and the traditional assembly mode is difficult to meet the special assembly requirements of laser-arc hybrid welding.

It is particularly stated here that although laser-arc hybrid welding has engineering characteristics such as small welding deformation, high manufacturing precision, strong penetration capability, good weld quality, fast welding speed, and high operating efficiency, it still has disadvantages that the laser-arc hybrid welding gun has large volume, a welding space is easily interfered, a traditional positioning and clamping device occupies a large amount of physical space when the laser-arc hybrid welding is used for the enclosed box-shaped structure and it is impossible to obtain full-automatic spatial welding of the enclosed box-shaped structure during laser-arc hybrid welding.

In a possible implementation, the enclosed box-shaped weld structure made of high-strength weather-resistant steel is adsorbed by arranging magnetic units 80 at the support table 60.

In a possible implementation, each of the magnetic units 80 is an electromagnet.

In a possible implementation, a plurality of high-precision electromagnets are embedded in the support table 60, and electromagnet adsorption control modules are distributed at multiple points along the length and width of the support table 60. The arrangement position of the electromagnet adsorption control modules is provided based on the workpiece support, positioning, and constraint requirements. Spacing between different electromagnet adsorption control modules is generally 500 to 800 mm. Meanwhile, the position of the electromagnet control module is continuously adjusted and accurately set with a control accuracy of 0.1 mm by a servo motor along the length, width, and height of the support table 60. A high-precision processing assembly is inlaid at each electromagnet adsorption control module to precisely position and support the box-shaped components. The magnetic field strength of the electromagnet adsorption control module can be adjusted by setting a magnitude of current to ensure that a support adsorption force of each module is digitally set and quantitatively adjusted between 0 and 50 KN. Through the precise control of the electromagnet position and adsorption force, anti-deformation amount precise setting, multi-point precise support positioning and multi-point flexible adsorption and compaction of the box-shaped with an inserted structure in the three directions of length, width and height can be implemented to ensure the precise assembly of the box-shaped structure and effectively constrain the welding process of the box-shaped structure. The assembly mode of electromagnet adsorption changes the unfavorable situation of many spatial physical interferences in traditional assembly, and guarantees the spatial accessibility of laser-arc hybrid welding to the greatest extent. Meanwhile, the assembly mode of electromagnet adsorption ensures precise setting of the spatial position and rigid constraints of the welding process, flexible compaction and dynamic regulation, and refined and real-time regulation capability of welding deformation is greatly improved

In a possible implementation, the electromagnet will not produce welding thermal demagnetization phenomenon compared with the permanent magnet, and the electromagnetic control module distributed with discrete point can independently output the spatial position and adsorption compaction force. The anti-deformation amount and adsorption compaction force can be regulated by the digital and real-time setting of the support position to regulate welding deformation flexibly and finely. Requirements for large-volume laser-arc hybrid welding gun, wide working space and the special assembly and welding requirements of strict assembly accuracy are satisfied.

In an embodiment of the present application, as shown in FIG. 1 to FIG. 7, the present solution provides a weld method based on a weld device, including:
obtaining a first weld characteristic value of the weld structure during a welding process, where the first weld characteristic value is a deformation amount parameter of the weld structure;
generating a first adjustment strategy for regulating a deformation amount of the weld surface of the weld structure based on the first weld characteristic value; and
performing anti-deformation adjustment in real time at the weld structure during the welding process based on the first adjustment strategy.

In detail, the present application further provides the weld method for the weld device, which solves defects of inability to avoid adjustment and correction to a weld structure, inability to effectively suppress welding deformation, large workload of repeated check, inability to accurately and dynamically adjust the weld structure based on the evolution trend of deformation and change amount of a weld structure, and poor anti-deformation effect. By adjusting a magnitude of the multi-point flexible force at the support surface, zero-gap rapid and precise assembly, multi-point flexible constraint and multi-energy field coordinated high-performance welding are provided, and engineering goals of fine control of welding deformation, effective suppression of welding defects and substantial improvement of weld microstructure performance are simultaneously achieved.

In an embodiment of the present application, obtaining the first weld characteristic value of the weld structure during the welding process includes:
obtaining a first deformation characteristic value, a second deformation characteristic value and a third deformation characteristic value of the weld structure during the welding process, where the first deformation characteristic value is a deformation area parameter of the weld structure, the second deformation characteristic value is a deformation force parameter corresponding to the first deformation characteristic value and the third deformation characteristic value is a friction force parameter corresponding to the first deformation characteristic value; and
generating the first weld characteristic value based on the first deformation characteristic value, the second deformation characteristic value and the third deformation characteristic value.

The present embodiment provides obtaining the first weld characteristic value of the weld structure during the welding process, and corresponding first weld characteristic value is generated by obtaining the deformation characteristic value of the weld structure during the welding process.

In an embodiment of the present application, generating the first adjustment strategy for regulating the deformation amount of the weld surface of the weld structure based on the first weld characteristic value includes:
obtaining a preset adjustment area corresponding to the weld surface of the weld structure, and obtaining all adjustment portions in the preset adjustment area based on the first deformation characteristic value;
generating a first adjustment characteristic value of each of obtained adjustment portions based on the second deformation characteristic value, where the first adjustment characteristic value is an adsorption force parameter of each of the obtained adjustment portions;
generating a second adjustment characteristic value of each of the obtained adjustment portions based on the second deformation characteristic value and the third deformation characteristic value, where the second adjustment characteristic value is a friction force parameter between each of the obtained adjustment portions and the weld structure; and
generating the first adjustment strategy for the preset adjustment area based on the first adjustment characteristic value and the second adjustment characteristic value.

The present embodiment provides an implementation for generating the first adjustment strategy for regulating the deformation amount of the weld surface of the weld structure, anti-deformation adjustment of the weld structure during the welding process is implemented by adjusting a magnitude of an adsorption force of the magnetic unit corresponding to the deformation area based on the adsorption force parameter.

Furthermore, when the magnitude of the adsorption force of the magnetic unit 80 is adjusted, the friction force parameter needs to be monitored to avoid the problem that the weld structure moves during the welding process due to insufficient adsorption force.

In an embodiment of the present application, generating the first adjustment strategy for the preset adjustment area based on the first adjustment characteristic value and the second adjustment characteristic value includes:
constructing a digital twin model based on the weld structure;
obtaining a first twin adjustment characteristic value of the digital twin model based on the first adjustment characteristic value;
obtaining a second twin adjustment characteristic value of the digital twin model based on the second adjustment characteristic value;
performing a determination based on the second twin adjustment characteristic value; and
generating the first adjustment strategy based on the first adjustment characteristic value in accordance with a determination that the second twin adjustment characteristic value satisfies a preset adsorption condition; or
generating the first adjustment strategy based on the second adjustment characteristic value in accordance with a determination that the second twin adjustment characteristic value does not satisfy a preset adsorption condition.

The present embodiment provides an implementation for generating the first adjustment strategy based on the preset adjustment area. By constructing the digital twin model, the anti-deformation amount of the weld structure is calculated, and the adsorption force parameter between the support table 60 and the weld structure are verified to avoid the problem that the weld structure moves on the support table 60 due to insufficient adsorption force of the magnetic unit 80.

In some possible embodiments of the present application, performing anti-deformation adjustment in real time at the weld structure during the welding process based on the first adjustment strategy includes:
obtaining an instant weld area of the weld structure and dynamically fitting the instant weld area with the preset adjustment area,
obtaining a dynamically fit first instant adjustment area and a dynamically fit second instant adjustment area, where the first instant adjustment area is an area corresponding to first deformation characteristic value, and the second instant adjustment area is an area within a preset range around the first instant adjustment area;
obtaining a magnetic field distortion parameter in the second instant adjustment area and performing a determination; and
generating the first adjustment strategy based on a preset distortion threshold in accordance with a determination that the magnetic field distortion parameter does not satisfy the preset distortion threshold.

The present embodiment provides performing anti-deformation adjustment in real time at the weld structure. By monitoring the magnetic field within the preset range around the deformation area of the weld structure, a problem of excessive disturbance to the magnetic field in the surrounding area caused by adjusting the magnetic unit 80 corresponding to the deformation area is avoided, the weld quality is guaranteed, and dynamic regulation of welding deformation in the hybrid welding process is satisfied to ensure engineering requirements of accurate weld position and enhanced weld stability.

In an embodiment of the present application, after performing anti-deformation adjustment in real time at the weld structure during the welding process based on the first adjustment strategy, the method further includes:
obtaining a second weld characteristic value and a third weld characteristic value of the weld structure during the welding process, where the second weld characteristic value is a welding trajectory parameter of the weld structure, and the third characteristic value is a weld pool parameter of the weld structure;
generating a second adjustment strategy for regulating a magnetic field direction of the adjustment portion based on the second weld characteristic value and the third weld characteristic value; and
stirring the weld pool of the weld structure during the welding process using magnetic field in real time based on the second adjustment strategy.

The present embodiment provides stirring the weld pool of the weld structure using the magnetic field. By coupling and regulating laser and arc energy fields of the laser-arc hybrid welding using an alternating magnetic field generated by the magnetic unit 80, a plasma is effectively suppressed, a droplet flight speed and a weld pool flow speed of the laser-arc hybrid welding are increased, the thermal transmission and energy efficiency of the laser and arc are improved, and more stable droplet transition and better arc directivity are obtained. A stirring effect of the magnetic field is formed inside the weld pool to further refine the weld grain structure and enhance the gas escape capability. The mechanical properties and fatigue strength of a hybrid weld joint under the superposition of the magnetic field are improved by at least 5% compared with the traditional hybrid weld joint.

It should be noted that the hybrid welding has concentrated heat source and small action area. It is extremely sensitive to the changes of spatial positions caused by the dynamic fine deformation during the welding process of large and complex components. If the fine deformation in the weld process is not intervened in real time, the cumulative deformation will also cause the subsequent weld position to deviate greatly, and the stability and reliability of the weld process is affected. Therefore, the weld deformation must be intervened in real time and dynamically regulated.

It should also be noted that gas escape is accelerated by utilizing the stirring effect of electromagnetic force inside the weld pool and welding porosity defects are effectively reduced by combining laser-arc hybrid welding and the magnetic field generated by electromagnet adsorption. An arc magnetic bias blowing phenomenon is suppressed by adjusting the direction of the electromagnetic force, and the arc and droplet transition is kept more stable. Through the coupling regulation of magnetic field, laser, and arc multi-energy field, the grain structure at a weld joint is further refined, and the mechanical properties and fatigue strength of the composite weld joint are significantly improved.

In other words, the present application changes the welding manufacturing mode of the enclosed box-shaped structure from structural design and development, weld device development to welding process development through the comprehensive application of the above innovative methods. The manufacturing accuracy, connection strength and welding quality of the enclosed inserted box-shaped component are significantly improved.

In the description of the embodiments of the present application, it should be noted that unless explicitly specified and defined otherwise, the terms “connected with” and “connected” shall be understood broadly, for example, it may be either fixedly connected or detachably connected, or can be integrated; it may be either mechanically connected, or electrically connected; it may be either directly connected, or indirectly connected through an intermediate medium. The specific meanings of the terms above in the present application can be understood by a person skilled in the art in accordance with specific conditions.

In the description of the present specification, description of reference terms “an embodiment”, “some embodiments”, “an example”, “specific example”, “some examples” and the like, refers to that specific features, structures, material or characteristics described in combination with an embodiment or an example are included in at least an embodiment or example according to the embodiments of the present application. In the present specification, schematic representations of the above terms are not necessarily directed to a same embodiment or example. Furthermore, the features, structures, material or characteristics described can be combined in any suitable manner in any one or more embodiments or examples. In addition, those skilled in the art may combine the different embodiments or examples described in this specification, as well as the features of the different embodiments or examples, without conflicting each other.

It should be noted that the above embodiments are only used to explain the solutions of the present application, and are not limited thereto. Although the present application has been described in detail with reference to the foregoing embodiments, it should be understood by those skilled in the art that modifications to the solutions documented in the foregoing embodiments and equivalent substitutions to a part of the features can be made and these modifications and substitutions do not make the corresponding solutions depart from the scope of the solutions of various embodiments of the present application.

1. A weld structure, comprising:
a first cover plate, a second cover plate, a plurality of web plates and a plurality of rib plates,
wherein the first cover plate and the second cover plate are arranged at intervals;
the web plates are arranged at intervals along a first direction and are insertedly matched with the first cover plate and the second cover plate, respectively;
the rib plates are arranged at intervals along a second direction and are insertedly matched with the first cover plate and the second cover plate, respectively;
the first direction and the second direction are perpendicular to each other; and
the web plates and the rib plates are insertedly matched with each other.

2. The weld structure of claim 1, wherein a surface of the first cover plate is provided with a plurality of first slots and a plurality of second slots,
wherein the first slots are arranged at intervals along the first direction and each of the first slots is insertedly matched with each of the web plates;
the second slots are arranged at intervals along the second direction and each of the second slots is insertedly matched with each of the rib plates; and
grooves are provided at sides of each of the first slots and the second slots facing the second cover plate.

3. The weld structure of claim 1, wherein a surface of the second cover plate is provided with a plurality of third slots and a plurality of fourth slots,
wherein the third slots are arranged at intervals along the first direction and each of the third slots is insertedly matched with each of the web plates;
the fourth slots are arranged at intervals along the second direction and each of the fourth slots is insertedly matched with each of the rib plates; and
grooves are provided at sides of each of the third slots and the fourth slots facing the first cover plate.

4. The weld structure of of claims 1, wherein the first cover plate, the second cover plate, the web plates and the rib plates are all made of high-strength weather-resistant steel.

5. A weld device for a weld structure of of claims 1, comprising: a support portion, a weld portion and an adjustment portion,
wherein the support portion is formed with a support surface for supporting the weld structure;
the weld portion is connected to the support portion for welding the weld structure; and
the adjustment portion is connected to the support portion and abuts against a weld surface of the weld structure,
wherein during a welding process of the weld structure by the weld portion, the adjustment portion regulates a flatness of the weld structure by adjusting a magnitude of a force acting on the weld surface of the weld structure.

6. The weld device for the weld structure of claim 5, wherein the support portion comprises: a support table and a drive unit,
wherein a surface of the support table forms the support surface; and
the drive unit is connected to the support table to adjust a rotation angle of the support table.

7. The weld device for the weld structure of claim 5, wherein the weld portion is a laser-arc hybrid welding mechanism connected with the support portion.

8. The weld device for the weld structure of claims 5, wherein the adjustment portion comprises: a plurality of magnetic units and a plurality of sensor units,
wherein the magnetic units are arranged at the support table to position the weld structure through magnetic adsorption; and
the sensor units are arranged at the support table to feed back welding parameters used in the welding process of the weld structure to the weld portion.

9. A weld method based on a weld device for the weld structure claims 5, comprising:
obtaining a first weld characteristic value of the weld structure during a welding process, wherein the first weld characteristic value is a deformation amount parameter of the weld structure;
generating a first adjustment strategy for regulating a deformation amount of the weld surface of the weld structure based on the first weld characteristic value; and
performing anti-deformation adjustment in real time at the weld structure during the welding process based on the first adjustment strategy.

10. The weld method of claim 9, wherein obtaining the first weld characteristic value of the weld structure during the welding process comprises:
obtaining a first deformation characteristic value, a second deformation characteristic value and a third deformation characteristic value of the weld structure during the welding process, wherein the first deformation characteristic value is a deformation area parameter of the weld structure, the second deformation characteristic value is a deformation force parameter corresponding to the first deformation characteristic value, and the third deformation characteristic value is a friction force parameter corresponding to the first deformation characteristic value; and
generating the first weld characteristic value based on the first deformation characteristic value, the second deformation characteristic value and the third deformation characteristic value.

11. The weld method of claim 9, wherein generating the first adjustment strategy for regulating the deformation amount of the weld surface of the weld structure based on the first weld characteristic value comprises:
obtaining a preset adjustment area corresponding to the weld surface of the weld structure, and obtaining all adjustment portions in the preset adjustment area based on the first deformation characteristic value;
generating a first adjustment characteristic value of each of obtained adjustment portions based on the second deformation characteristic value, wherein the first adjustment characteristic value is an adsorption force parameter of each of the obtained adjustment portions;
generating a second adjustment characteristic value of each of the obtained adjustment portions based on the second deformation characteristic value and the third deformation characteristic value, wherein the second adjustment characteristic value is a friction force parameter between each of the obtained adjustment portions and the weld structure; and
generating the first adjustment strategy for the preset adjustment area based on the first adjustment characteristic value and the second adjustment characteristic value.

12. The weld method of claim 11, wherein generating the first adjustment strategy for the preset adjustment area based on the first adjustment characteristic value and the second adjustment characteristic value comprises:
constructing a digital twin model based on the weld structure;
obtaining a first twin adjustment characteristic value of the digital twin model based on the first adjustment characteristic value;
obtaining a second twin adjustment characteristic value of the digital twin model based on the second adjustment characteristic value;
performing a determination based on the second twin adjustment characteristic value; and
generating the first adjustment strategy based on the first adjustment characteristic value in accordance with a determination that the second twin adjustment characteristic value satisfies a preset adsorption condition; or
generating the first adjustment strategy based on the second adjustment characteristic value in accordance with a determination that the second twin adjustment characteristic value does not satisfy a preset adsorption condition.

13. The weld method of claim 11, wherein performing anti-deformation adjustment in real time at the weld structure during the welding process based on the first adjustment strategy comprises:
obtaining an instant weld area of the weld structure and dynamically fitting the instant weld area with the preset adjustment area;
obtaining a dynamically fit first instant adjustment area and a dynamically fit second instant adjustment area, wherein the first instant adjustment area is an area corresponding to first deformation characteristic value, and the second instant adjustment area is an area within a preset range around the first instant adjustment area;
obtaining a magnetic field distortion parameter in the second instant adjustment area and performing a determination; and
generating the first adjustment strategy based on a preset distortion threshold in accordance with a determination that the magnetic field distortion parameter does not satisfy the preset distortion threshold.

14. The weld method of claims 9, wherein after performing anti-deformation adjustment in real time at the weld structure during the welding process based on the first adjustment strategy, the method further comprises:
obtaining a second weld characteristic value and a third weld characteristic value of the weld structure during the welding process, wherein the second weld characteristic value is a welding trajectory parameter of the weld structure, and the third characteristic value is a weld pool parameter of the weld structure;
generating a second adjustment strategy for regulating a magnetic field direction of the adjustment portion based on the second weld characteristic value and the third weld characteristic value; and stirring the weld pool of the weld structure during the welding process using magnetic field in real time based on the second adjustment strategy.

15. The weld method of claim 12, wherein performing anti-deformation adjustment in real time at the weld structure during the welding process based on the first adjustment strategy comprises:
obtaining an instant weld area of the weld structure and dynamically fitting the instant weld area with the preset adjustment area;
obtaining a dynamically fit first instant adjustment area and a dynamically fit second instant adjustment area, wherein the first instant adjustment area is an area corresponding to first deformation characteristic value, and the second instant adjustment area is an area within a preset range around the first instant adjustment area;
obtaining a magnetic field distortion parameter in the second instant adjustment area and performing a determination; and
generating the first adjustment strategy based on a preset distortion threshold in accordance with a determination that the magnetic field distortion parameter does not satisfy the preset distortion threshold.
